(19) United States
(12) Patent Application Publication
(10) Pub. No.: US 2017/0234400 A1
(43) Pub. Date: Aug. 17, 2017

(54) BLADE-TYPE TORSIONAL DAMPER

(71) Applicant: VALEO EMBRAYAGES, Amiens Cedex 2 (FR)

(72) Inventors: Daniel FENIOUX, Saleux (FR); Herve MAUREL, Amiens (FR)

(21) Appl. No.: 15/514,989

(22) PCT Filed: Sep. 24, 2015
(86) PCT No.: PCT/EP2015/072020

§ 371 Date: Mar. 28, 2017

(30) Foreign Application Priority Data
Oct. 1, 2014 (FR) 1459348

(51) Int. Cl. F16F 15/121; F16D 3/00; F16F 3/02; F16D 3/12

(52) U.S. Cl. CPC F16F 15/1215; F16D 3/12; F16D 3/005; F16F 3/023; F16F 2236/027; F16F 2238/022; F16F 2230/0064

(57) ABSTRACT

A torsional damper for a torque transmission device, comprising:
a first element (1) and a second element (2) rotationally movable with respect to one another; and
a first damping means and a second damping means, each damping means comprising:
   an elastically deformable blade (9) having a fastening portion (12) and an elastic portion (13),
   an abutment element carried by the other of the first and second elements and configured, for an angular deflection between the first and second elements with respect to an inactive angular position, to apply a flexural load onto the blade,
      the elastic portion of the blade of the first damping means proceeds circumferentially beyond the fastening portion of the blade of the second damping means.

The invention relates to a torsional damper intended to be installed on a torque transmission device. The invention relates more specifically to the sector of motor vehicle transmissions.

### BACKGROUND OF THE INVENTION

In the sector of automotive transmissions, it is known to equip the torque transmission devices with torsional dampers that allow the vibrations and irregularities generated by an internal combustion engine to be absorbed and damped.

The torsional dampers have an input element and an output element that are rotationally movable around a common rotation axis, and elastic damping means for transmitting torque and for damping rotational irregularities between the input element and output element.

Torsional dampers of this kind are installed, in particular, on dual mass flywheels (DMFs), on friction clutches in the case of a manual or automated transmission, or on “lock-up” clutches that are installed on hydraulic coupling devices in the case of an automatic transmission.

The document FR 3000155 depicts a torsional damper having two elastic damping means each formed by an elastic blade mounted on the input element and each interacting with a cam follower mounted on the output element.

The blade and the cam follower of each elastic damping means are configured in such a way that for an angular deflection between the input element and output element on either side of an inactive relative angular position, the cam follower moves along the blade and, in so doing, applies a flexural load onto the elastic blade. In reaction, the elastic blade exerts on the cam follower a return force that tends to bring the input and output elements back to their inactive angular position. Flexure of the elastic blade thus allows damping of the vibrations and rotational irregularities between the input element and output element while ensuring the transmission of torque.

Such blades are subject to excessive stress when the torque to be transmitted is high, however, and are therefore not adapted for transmitting high torques.

### OBJECT OF THE INVENTION

One aspect of the invention arises from the idea of eliminating the disadvantages of the existing art by proposing an elastic blade-type torsional damper which is particularly effective, and in which the elastic blades are subjected to lower stresses.

According to an embodiment, the invention furnishes a torsional damper for a torque transmission device, comprising:
a first element and a second element rotationally movable with respect to one another around a rotation axis X; and
a first damping means and a second damping means for transmitting a torque and for damping rotational irregularities between the first element and the second element, each damping means comprising:
   an elastically deformable blade integral with one of said first and second elements and having a portion for fastening the blade to said first or second element and an elastic portion, the elastic portion proceeding circumferentially from the fastening portion to a free distal end,
   an abutment element carried by the other of said first and second elements and configured to interact with the elastic portion of the blade of said damping means, the elastic portion of the blade being configured such that for an angular deflection between the first and second elements with respect to an inactive angular position, the abutment element applies a flexural load onto the blade, producing jointly a reaction force capable of returning the first and second elements to said inactive angular position,

said damper being characterized in that the elastic portion of the blade of the first damping means proceeds circumferentially beyond the fastening portion of the blade of the second damping means, in such a way that at least part of the elastic portion of the blade of the second damping means is arranged radially between the free distal end of the blade of the first damping means and the rotation axis X.

The fact that one blade proceeds circumferentially beyond the fastening portion of the other blade, i.e. an interweaving of the blades, thus allows the blades to proceed over greater lengths. Such longer blades are subjected to lower stresses, which allows the transmission of elevated torques.

In addition, a blade configuration of this kind is capable of offering a blade surface with which the abutment element, having a greater circumferential length, interacts. This additional circumferential length of the blade surface with which the abutment element interacts allows a greater angular deflection between the elements, which allows a decrease in the stiffness of the blade and consequently better damping of engine irregularities.

According to other advantageous embodiments, a torsional damper of this kind can have one or more of the following characteristics:
The blade is configured to deform in a plane perpendicular to the rotation axis X.
The fastening portion of the blade is fixed with respect to the element on which the blade is fastened.
The elastic portion of the blade has a cam surface, and the abutment element has a cam follower configured to interact with the cam surface, the cam surface being configured in such a way that for an angular deflection between the first and second elements with respect to an inactive angular position, the cam follower applies a flexural load onto the blade, producing jointly a reaction force capable of returning the elements to said inactive angular position.
In the inactive angular position, the elastic portion of the blade of the first damping means and the elastic portion of the blade of the second damping means are both arranged radially between the abutment element of the first damping means and the rotation axis X.
The elastic blade of the second damping means proceeds circumferentially beyond the fastening portion of the blade of the first damping means, so that the elastic portion of the blade of the first damping means is arranged radially between the free distal end of the blade of the second damping means and the rotation axis X.
In the inactive angular position, the elastic portion of the blade of the first damping means and the elastic portion of the blade of the second damping means are both arranged radially between the abutment element of the second damping means and the rotation axis X.
The abutment elements of the first and of the second damping means are respectively arranged radially outside the blades of the first and the second damping means.
The elastic portion of each blade comprises:
   a first portion proceeding from the fastening portion of the blade,
   a bent portion which is a prolongation of the first portion, and
   a second portion which is a circumferential prolongation of the bent portion, and in which:
   the fastening portion of the blade of the first damping means is diametrically opposite the fastening portion of the blade of the second damping means with respect to the rotation axis X,
   at least part of the first portion of the blade of the second damping means is arranged radially between the second portion of the blade of the first damping means and the rotation axis X, and
   at least part of the fastening portion of the blade of the second damping means is arranged radially between the bent portion of the blade of the first damping means and the rotation axis X.
For each blade, the bent portion has a radius of curvature smaller than the radius of curvature of the first portion and than the radius of curvature of the second portion.
For each blade, the second portion has a radius of curvature smaller than the radius of curvature of the first portion.
The first portion has a thickness which is less than the width of the second portion.
The first damping means is symmetrical to the second damping means with respect to the rotation axis X.
The abutment elements are wheels mounted rotationally movably on the respective first or second element by means of a rolling bearing.
The blades of the first and the second damping means are fastened independently to their respective first or second element.
Each blade extends circumferentially over at least 180°.

The invention also relates to a torque transmission element, in particular for a motor vehicle, having an aforementioned torsional damper.

According to other advantageous embodiments, a transmission element of this kind can have one or several of the following characteristics:
The transmission element has two aforementioned torsional dampers arranged in series.
The transmission element has two aforementioned torsional dampers arranged in parallel.

One aspect of the invention arises from the idea of reducing the stiffness of the damping means in order to allow better damping of irregularities. One aspect of the invention arises from the idea of increasing the maximum angular deflection between the input element and the output element. One aspect of the invention arises from the idea of reducing the stress concentration zones on a spring blade. One aspect of the invention arises from the idea of limiting the radial size of a spring blade without impeding the damping of irregularities. One aspect of the invention is to propose a torsional damper having blades subject to acceptable stresses upon the transmission of a high torque. One object of the invention is to furnish a torsional damper permitting high-quality filtering of irregularities. One object of the invention is to furnish a torsional damper allowing a large angular deflection. One object of the invention is to reduce the stiffness of the blades. One object of the invention is to furnish an elastic blade having a cam surface intended to interact with the long cam follower.

The invention will be better understood, and other objectives, details, characteristics, and advantages thereof will appear more clearly, in the course of the description below of several specific embodiments of the invention provided solely for illustrative and not for limiting purposes, with reference to the attached Figures.

In those Figures:

FIG. 1 is a schematic exploded perspective view of a torsional damper;

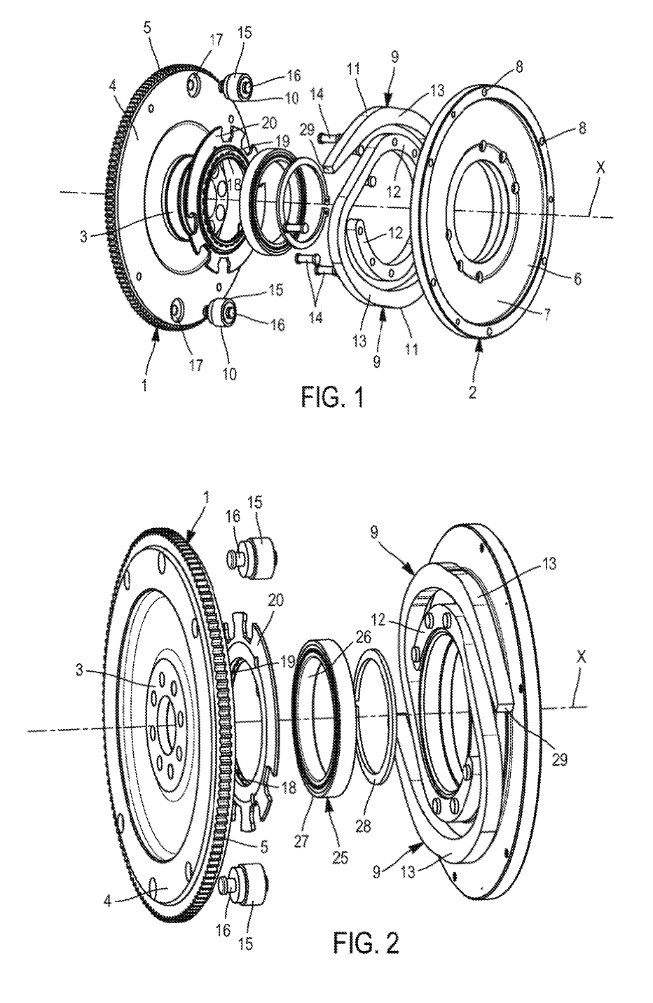

FIG. 2 is a schematic exploded perspective view of the torsional damper of FIG. 1 in a different orientation;

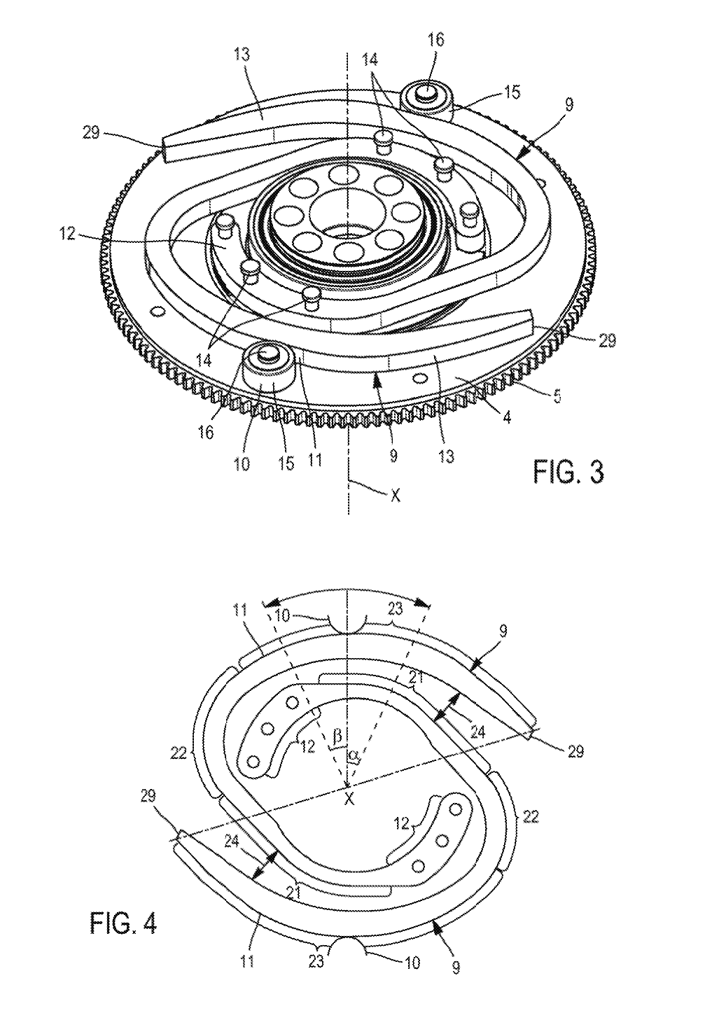

FIG. 3 is a schematic perspective view of the torsional damper of FIGS. 1 and 2 in an assembled state, and in which the output element is not depicted;

FIG. 4 is a schematic top view of the damping means of the torsional damper of FIGS. 1 and 2.

In the description and the claims, the terms “outer” and “inner” and the “axial” and “radial” orientations will be used to designate elements of the torsional damper in accordance with the definitions given in the description. By convention, the “radial” orientation is directed orthogonally to the rotation axis (X) of the elements of the torsional damper determining the “axial” orientation; and, moving away from said axis from inside to outside, the “circumferential” orientation is directed orthogonally to the axis of the torsional damper and orthogonally to the radial direction. An element described as proceeding “circumferentially” is thus an element one component of which proceeds in a circumferential direction. The terms “outer” and “inner” are used to define the relative position of one element with respect to another with reference to the rotation axis of the torsional damper; an element close to the axis is thus referred to as “inner,” as opposed to an “outer” element situated radially at the periphery.

The torsional damper illustrated in FIGS. 1 to 3 is intended to be incorporated into a transmission element of the transmission drivetrain of a motor vehicle. That transmission element can be, for example, an engine flywheel equipped with a torsional damper such as a dual mass flywheel, a lock-up clutch, of a hydraulic coupling device, or a friction clutch. Note furthermore that in the case of a friction clutch, the torsional damper according to the invention can constitute a principal damper and/or a pre-damper.

The torsional damper has an input element 1 and an output element 2 that are arranged in the transmission drivetrain respectively on the internal combustion engine side and on the gearbox side. As an example, in the embodiment depicted in FIGS. 1 to 4 the torsional damper is incorporated into a dual mass flywheel, input element 1 being constituted by a first flywheel intended to be fastened at the end of a driving shaft such as the crankshaft of an internal combustion engine, while output element 2 is constituted by a second flywheel forming, in general, a reaction plate of a clutch for coupling to a driven shaft, such as the input shaft of a gearbox.

Input element 1 and output element 2 are rotationally movable around a common rotation axis X. Input element 1 and output element 2 are rotationally guided with respect to one another by means of a bearing such as a rolling bearing 25. A rolling bearing 25 of this kind is supported by a hub 3 of input element 1. Rolling bearing 25 has an inner ring 26 mounted on input element 1 and an outer ring 27 mounted on output element 2. Radially inner hub 3 of input element 1 has a shoulder that serves for abutment of inner ring 26 of rolling bearing 25 and retains said inner ring 26 in the direction of the engine. Inner ring 26 is furthermore retained on input element 1, in a direction opposite from the engine, by a circlip 28. Output element 2 has on its inner periphery a shoulder that serves for abutment of outer ring 27 of rolling bearing 25 and retains said outer ring 27 in a direction opposite from the engine. Outer ring 27 is force-mounted onto output element 2.

Input element 1 has an annular portion 4 proceeding radially from hub 3. This annular portion 4 has means (not depicted) for fastening to the driving shaft, for example in the form of orifices intended to interact with rivets for fastening onto the driving shaft. In addition, an outer periphery of annular portion 4 has a ring gear 5 for driving input element 1 rotationally with the aid of a starter.

Output element 2 has a planar annular portion 6. In the context of a dual mass flywheel this annular portion 6 forms, on a face opposite from input element 1, an abutment surface 7 for a friction lining of a clutch disc (not depicted). Output element 2 then has, in the vicinity of its outer edge, orifices 8 that serve for mounting of a clutch cover.

Input element 1 and output element 2 are rotationally connected by damping means. The damping means are capable of transmitting a driving torque from input element 1 to output element 2 (forward direction) and a resistive torque from output element 2 to input element (reverse direction). The damping means furthermore develop an elastic return torque that tends to return input element 1 and output element 2 to an inactive relative angular position.

Referring to FIGS. 1 to 3, the torsional damper has a first damping means and a second damping means that are symmetrical with respect to a rotation axis X. Each damping means has on the one hand an elastic blade 9 and on the other hand a cam follower 10. Elastic blade 9 is mounted rotationally integrally with output element 2. Cam follower 10 is mounted rotationally integrally with input element 1. In another embodiment that is not depicted, the elastic blade is mounted rotationally integrally with the input element, and the cam follower is mounted rotationally integrally with the output element.

The torsional vibrations and torque inconsistencies that are produced by the internal combustion engine are transmitted by the driving shaft to the input element, and generate relative rotations between the input element and output element. These vibrations and inconsistencies are damped by the flexing of the elastic blade. For this, elastic blade 9 has a cam surface 11 that is configured to interact with cam follower 10. Elastic blade 9 is designed to be able to withstand significant stresses of up to 1500 MPa. Elastic blade 9 is made of a steel, for example the 51CrV4 steel type which has undergone specific heat treatments, such as quenching followed by tempering.

Elastic blade 9 has a fastening portion 12 that is fixed with respect to output element 2 in order to allow rotational integration of elastic blade 9 on output element 2. Fastening portion 12, fastened on output element 2, is prolonged by an elastic portion 13 which is deformable in order to damp irregularities of the engine.

Fastening portion 12 proceeds circumferentially and radially at a distance from hub 3 of input element 1. In the embodiment depicted in FIGS. 1 to 3, fastening portion 12 of each damping means is fastened to output element 2 with three rivets 14. In order to ensure proper fastening of elastic blade 9, the three rivets 14 are not aligned along the same axis. Fastening of an elastic blade using fewer than three rivets 14 would not ensure proper fastening. Furthermore, fastening elastic blade 9 using a greater number of rivets 14 would produce a space problem in the case of rivets having the same dimensions, and a mechanical strength problem in the case of rivets having smaller dimensions.

Elastic portion 13 carries cam surface 11 that interacts with cam follower 10. Cam surface 11 proceeds circumferentially with a radius of curvature determined as a function of the desired stiffness of elastic blade 9. This cam surface can have different radii of curvature depending on the specific stiffness values desired, in order to allow changes in the slope of the characteristic curve of the torsional damper representing the torque transmitted as a function of angular deflection. The elastic blade is described in more detail below with reference to FIG. 4.

Cam follower 10 of each damping means has a wheel 15 carried by a cylindrical rod 16. Rod 16 is mounted fixedly in a receptacle 17 of input element 1. In order to reduce parasitic friction capable of affecting damping functionality, wheel 15 is advantageously mounted on cylindrical rod 16 rotatably around a rotation axis parallel to rotation axis X. Wheel 15 is mounted on rod 16, for example, by means of a rolling bearing such as a ball bearing or roller bearing. In an embodiment, wheel 15 has an anti-friction coating.

Wheel 15 is kept in abutment against cam surface 11 and is configured to roll against said cam surface 11 upon a relative movement between input element 1 and output element 2. Wheel 15 is arranged radially outside cam surface 11 in order to locate elastic blade 9 radially when it is subjected to centrifugal force.

The torsional damper furthermore has friction members configured to exert a resistive torque between input element 1 and output element 2 upon relative deflection thereof. The friction members are thus capable of dissipating the energy accumulated in elastic blades 9. The friction members comprise a fastening ring 18, an elastic washer 19, and a plastic washer 20. Fastening ring 18 is received in a groove of hub 3 of input element 1. Elastic washer 19 applies onto plastic washer 20 an axial load allowing it to be set against first element 1. Plastic washer 20 has on its outer periphery a tooth set that meshes, with a determined circumferential play, with rivets for fastening elastic blades 9 onto output element 2. When the circumferential play is taken up upon a relative deflection between input element 1 and output element 2, plastic washer 20 is thus rotationally driven with output element 2, and a frictional torque is exerted between plastic washer 20 and input element 1.

FIG. 4 schematically depicts elastic blades 9 and cam followers 10 associated with the first damping means and the second damping means.

Elastic portion 13 of each elastic blade 9 has a first portion 21, a bend 22, and a second portion 23. First portion 21 of the blade is a prolongation of fastening portion 12 of elastic blade 9. Bend 22 is a prolongation of first portion 21 of elastic blade 9. First portion 21 has on the one hand a first part proceeding circumferentially from fastening portion 12, and on the other hand a second part proceeding substantially rectilinearly in such a way that bend 22 of elastic blade 9 is diametrically opposite fastening portion 12 with respect to rotation axis X. Formation of this second rectilinear part of first portion 21 is possible because fastening portion 12 is at a radial distance with respect to hub 3 of input element 1. Bend 22 is radially farther away from rotation axis X than fastening portion 12.

Second portion 23 is a prolongation of bend 22. Second portion 23 extends substantially circumferentially from bend 22 to free end 29 of blade 9. Cam surface 11 proceeds over an outer face of second portion 23. Advantageously, cam surface 11 proceeds circumferentially over an angle of approximately 125° to 130°. The radius of curvature of second portion 23, in particular the radius of curvature of the outer face defining cam surface 11, is determined as a function of the desired stiffness of elastic blade 9.

Elastic blades 9 of the damping means depicted schematically in FIG. 4 are symmetrical with respect to rotation axis X. First portion 21 of an elastic blade 9 is disposed radially between second portion 23 of the other elastic blade 9 and rotation axis X. In addition, bend 22 of an elastic blade 9 is disposed circumferentially beyond second portion 23 of the other elastic blade 9. The rectilinear shape of first portion 21, as well as the circumferential arrangement of bend 22 of the respective first and second elastic blade 9 with respect to second portion 23 of the respective second and first elastic blade 9, ensure the presence of a space 24 between first portion 21 of the respective first and second elastic blade 9 and second portion 23 of the respective second and first elastic blade 9. This space 24 allows deformation and radial deflection of second portion 23 of the respective first and second elastic blade 9, and thus the possibility of decreasing the stiffness of elastic blade 9 in order to permit better filtering of irregularities.

In addition, the arrangement of bend 22 of an elastic blade 9 as close as possible circumferentially to free end 29 of the other elastic blade 9 allows a very long second portion 23 to be implemented. Cam surface 11, situated on the outer face of that second portion, can thus also proceed circumferentially over a great length. Cam follower 10 thus has a large angular deflection, offering the possibility of reducing the stiffness of the blade in order to provide better damping.

The thickness of second portion 23 of elastic blade 9 in a radial direction is advantageously greater than the thickness of first portion 21 of elastic blade 9 in a radial direction. This configuration of the thicknesses of elastic blade 9 allows elastic deformation of elastic blade 9 at first portion 21 preferentially to deformation at second portion 23.

When a driving torque is transmitted from input element 1 to output element 2 (forward direction), the torque to be transmitted causes a relative deflection between input element 1 and output element 2 in a first direction. Wheel 15 is then displaced over an angle α (see FIG. 4) with respect to elastic blade 9. The displacement of wheel 15 on cam surface 11 causes flexure of elastic blade 9. The flexural load depends in particular on the geometry of elastic blade 9 and on its material, in particular its transverse modulus of elasticity. The tangential component of the flexural load allows transmission of the engine torque. In reaction, elastic blade 9 exerts on wheel 15 a reaction force whose tangential component constitutes a return force that tends to bring input element 1 and output element 2 back to their inactive relative angular positions.

When a resistive torque is transmitted from output element 2 to input element 1 (reverse direction), the torque to be transmitted causes a relative deflection between input element 1 and output element 2 in a second, opposite direction. Wheel 21 is then displaced over an angle β (see FIG. 4) with respect to the elastic blade. In this case the tangential component of the flexural load is in a direction opposite from the tangential component of the flexural load for driving in the forward direction. Similarly, elastic blade 9 exerts a reaction force in a direction opposite from the one in the forward direction, so as to bring output element 2 and input element 1 back to their inactive relative angular positions. Bend 22 of an elastic blade 9, constituting the zone that is most heavily stressed upon a deformation of elastic blade 9, is advantageously arranged circumferentially as close as possible to fastening zone 12, so as to offer as much deflection as possible in the reverse direction while leaving the space necessary for good operation thereof and for deformation of the other elastic blade 9. A torsional damper of this kind can thus advantageously exhibit, from the inactive position, a deflection on the order of 90° in a forward direction and a deflection on the order of 35° to 40° in a reverse direction.

Although the invention has been described in conjunction with several specific embodiments, it is quite apparent that it is in no way limited thereto, and that it encompasses all the technical equivalents of the means described as well as combinations thereof, if they are within the scope of the invention.

In particular, the damping means can be independent of one another, or connected to one another via a central segment. It is likewise possible to integrate one of the damping means with one of the elements, and the other of the damping means with the other of the elements.

Use of the verbs “have,” “comprise” or “include” and of their conjugated forms does not exclude the presence of elements or steps other than those recited in a claim. Use of the indefinite article “a” or “an” for an element or a step does not, unless otherwise indicated, exclude the presence of a plurality of such elements or steps.

In the claims, no reference character in parentheses shall be interpreted as a limitation of the claim.

1. A torsional damper for a torque transmission device, comprising:
a first element (1) and a second element (2) rotationally movable with respect to one another around a rotation axis X; and
a first damping means and a second damping means for transmitting a torque and for damping rotational irregularities between the first element and the second element, each damping means comprising:
an elastically deformable blade (9) integral with one of said first and second elements and having a portion (12) for fastening the blade to said first or second element and an elastic portion (13), the elastic portion proceeding circumferentially from the fastening portion to a free distal end (29),
an abutment element (10) carried by the other of said first and second elements and configured to interact with the elastic portion of the blade of said damping means, the elastic portion of the blade being configured such that for an angular deflection between the first and second elements with respect to an inactive angular position, the abutment element applies a flexural load onto the blade, producing jointly a reaction force capable of returning the first and second elements to said inactive angular position,
the elastic portion of the blade of the first damping means proceeds circumferentially beyond the fastening portion of the blade of the second damping means, in such a way that at least part of the elastic portion of the blade of the second damping means is arranged radially between the free distal end of the blade of the first damping means and the rotation axis X.

2. The torsional damper according to claim 1, wherein the elastic portion of the blade has a cam surface (11); and wherein the abutment element has a cam follower configured to interact with the cam surface, the cam surface being configured in such a way that for an angular deflection between the first and second elements with respect to an inactive angular position, the cam follower applies a flexural load onto the blade, producing jointly a reaction force capable of returning the elements to said inactive angular position.

3. The torsional damper according to claim 1, wherein the inactive angular position, the elastic portion of the blade of the first damping means and the elastic portion of the blade of the second damping means are both arranged radially between the abutment element of the first damping means and the rotation axis X.

4. The torsional damper according to claim 1, wherein the elastic blade of the second damping means proceeds circumferentially beyond the fastening portion of the blade of the first damping means, so that the elastic portion of the blade of the first damping means is arranged radially between the free distal end of the blade of the second damping means and the rotation axis X.

5. The torsional damper according to claim 4, wherein the inactive angular position, the elastic portion of the blade of the first damping means and the elastic portion of the blade of the second damping means are both arranged radially between the abutment element of the second damping means and the rotation axis X.

6. The torsional damper according to claim 1, wherein the abutment elements of the first and of the second damping means are respectively arranged radially outside the blades of the first and the second damping means.

7. The torsional damper according to claim 1, wherein the elastic portion of each blade comprises:
a first portion (21) proceeding from the fastening portion of the blade,
a bent portion (22) which is a prolongation of the first portion, and
a second portion (23) which is a circumferential prolongation of the bent portion;
and wherein:
the fastening portion of the blade of the first damping means is diametrically opposite the fastening portion of the blade of the second damping means with respect to the rotation axis X,
at least part of the first portion of the blade of the second damping means is arranged radially between the second portion of the blade of the first damping means and the rotation axis X, and
at least part of the fastening portion of the blade of the second damping means is arranged radially between the bent portion of the blade of the first damping means and the rotation axis X.

8. The torsional damper according to claim 7, wherein for each blade, the bent portion has a radius of curvature smaller than the radius of curvature of the first portion and the radius of curvature of the second portion.

9. The torsional damper according to claim 7, wherein for each blade, the second portion has a radius of curvature smaller than the radius of curvature of the first portion.

10. The torsional damper according to claim 7, wherein the first portion has a thickness which is less than the width of the second portion.

11. The torsional damper according to claim 1, wherein the first damping means is symmetrical to the second damping means with respect to the rotation axis X.

12. The torsional damper according to claim 1, wherein the abutment elements are wheels mounted rotationally movably on the respective first or second element by means of a rolling bearing.

13. The torsional damper according to claim 1, wherein the blades of the first and the second damping means are fastened independently to the first or second element.

14. The torsional damper according to claim 1, wherein each blade extends circumferentially over at least 180°.

15. A torque transmission element, in particular for a motor vehicle, having a torsional damper according to claim 1.

16. The torsional damper according to claim 2, wherein the inactive angular position, the elastic portion of the blade of the first damping means and the elastic portion of the blade of the second damping means are both arranged radially between the abutment element of the first damping means and the rotation axis X.

17. The torsional damper according to claim 2, wherein the elastic blade of the second damping means proceeds circumferentially beyond the fastening portion of the blade of the first damping means, so that the elastic portion of the blade of the first damping means is arranged radially between the free distal end of the blade of the second damping means and the rotation axis X.

18. The torsional damper according to claim 3, wherein the elastic blade of the second damping means proceeds circumferentially beyond the fastening portion of the blade of the first damping means, so that the elastic portion of the blade of the first damping means is arranged radially between the free distal end of the blade of the second damping means and the rotation axis X.
